(19) United States
(12) Patent Application Publication
(10) Pub. No.: US 2003/0000480 A1
(43) Pub. Date: Jan. 2, 2003

(54) Marine Eco-Habitat System

(76) Inventor: Jeffrey Dale Jenkins, Libertyville, IL (US)

Correspondence Address: Jeffrey D. Jenkins, 512 AMES STREET, LIBERTYVILLE, IL, 60048, US

(21) Appl. No.: 10/101,932

(22) Filed: Mar. 21, 2002

Related U.S. Application Data
(60) Provisional application No. 60/277,272, filed on Mar. 21, 2001.

(51) Int. Cl. A01K 61/00

(52) U.S. Cl. 119/221

(57) ABSTRACT

An aquatic habitat made up of thin walled, symmetrically spaced plastic tubes vertically projecting from a thick walled base. The length of the tubes are pre-determined by the size of the base. Weep holes at the bottom of the tubes and between the tubes allow air to escape during installation into the marine environment. The vertical tubes, by design, act as a rudder to right the structure during its descent to the marine floor, thus allowing the installer to install the structure from above the waters surface.

### CROSS REFERENCE TO RELATED APPLICATIONS

| | | | |
|---|---|---|---|
| 3,898,958 | 8/1975 | Pranis, jr. | 119/3 |
| 4,061,110 | 12/1977 | Steidle | 119/4 |
| 4,165,711 | 8/1979 | Aoki | 119/3 |
| 4,244,323 | 1/1981 | Morimura | 119/3 |
| 4,266,509 | 5/1981 | Gollott et al. | 119/2 |
| 4,316,431 | 2/1982 | Kimura | 119/3 |
| 4,465,399 | 8/1984 | Kikuzawa et al. | 405/32 |
| 4,703,719 | 11/1987 | Mori | 119/3 |
| 4,736,708 | 4/1988 | Yoder | 119/2 |
| 4,913,094 | 4/1990 | Jones et al. | 119/3 |
| 4,947,791 | 8/1990 | Laier et al. | 119/3 |
| 5,038,715 | 8/1991 | Fahs, II | 119/3 |
| 5,109,796 | 5/1992 | Monus | 119/3 |

### STATEMENT REGARDING FED SPONSORED R & D

N/A

### APPENDIX

| | |
|---|---|
| Drawing (FIG. 1) | Cover |
| Descriptive Title of Invention | Page 1 |
| Related Applications | Page 1 |
| Appendix | Page 2 |
| Background of the Invention | Page 2 |
| Brief Summary of the Invention | Page 3 |
| Brief Description of the Drawing | Page 3 |
| Detailed Description | Page 3-4 |
| Abstract of the Disclosure | Page 5 |
| Claims | Page 6-7 |

### BACKGROUND OF THE INVENTION

1. Field of the Invention

This invention relates to aquatic habitats. In particular to this inventions multiple vertical tubes extending from a supporting base designed to rest submerged on the marine floor.

2. Prior Art

Many types if aquatic habitats have been suggested or proposed in prior art including U.S. Pat. Nos. 5,109,796; 5,038,715; 4,947,791; 4,913,094; 4,736,708; 4,703,719. Though all the habitats provide many various methods, shapes, materials and function, they all specifically have a restrictive water flow capability, which in turn allows siltation and damming of waterway debris, thus burying the prior art. Though any marine floor structure is susceptible to collective debris, this invention allows for the free flow of water past the vertical tubes thus improving on any prior habitat design.

### BRIEF SUMMARY OF THE INVENTION

The Marine Eco-Habitat System is manufactured into one unit. A plastic molded four-sided base containing two cross members has multiple vertical plastic tubes symmetrically spaced projecting perpendicular from the base structure. The plastic tubes are press fit into the fresh, hot molded base during the manufacture process, which creates a permanent bond once cooled.

### BRIEF DESCRIPTION OF THE DRAWING

Those having ordinary skills can best understand the Marine Eco-Habitat System by referring to FIG. 1:

FIG. 1 is a three dimensional perspective of the invention.

### DETAILED DESCRIPTION

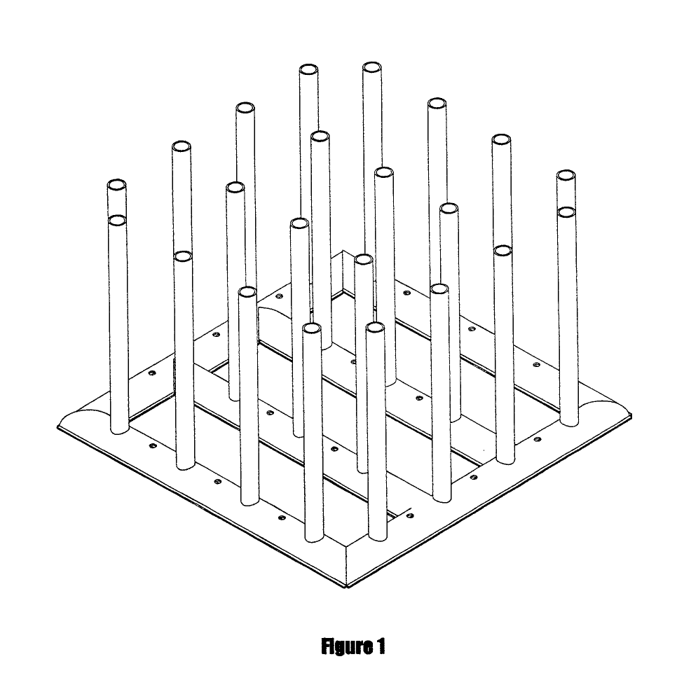

Throughout the following detailed descriptive please refer to the numeric drawings noted as FIG. 1. The strength of the structure shown in FIG. 1 comes from the strength of the base. When this invention is manufactured in a small size, the base is molded and while fresh out of the mold, coupled to the symmetrically spaced vertical tubes. The purpose of the symmetrical spacing is for structural weight balance. The tubes are then pressed down into a deep socket, which has a vent hole in the bottom. The purpose of the vent hole is to allow air to escape from the top of the tube once the structure is eventually installed into a marine environment. Air freely flows out the top of the tubes as the structure slowly sinks under its own weight. Prior to total submersion, water squirts out of the top of the tubes, which begins a type of propulsion of water. Once totally submerged, the descent of the structure remains consistent and vertical due to the water flowing through the tubes thus assuring a flat landing on the marine floor. The size of the hole in the base structure at the vertical tube can be made small for a slow descent to the marine floor, or large for a fast descent. Weep holes, as shown between the vertical tubes, also allow air to escape from the base thus increasing the structures gravitational pull to the marine floor. The vertical tubes are generally thin walled while the base has thick walls making the unit bottom heavy, which assists in the proper descent to the marine floor. In a large structure size, all of the same factors exist except for the base structure. When building a 30′×30′ base, with 20′ vertical members automation is not as productive as a small structure, however the large structure is pieced together on site on a floating platform and again launched to its descent while instilling the integrity of the structure by design. The hollowed out half round base slows the structure during its descent while also is designed to minimize siltation, sedimentation and debris collection at the marine floor.

Having described my invention, what is claimed and desired to be secured by Letters Patent is:

1. A aquatic habitat manufacture in one piece

2. A aquatic habitat according to claim 1 that can be mass produced

3. A aquatic habitat according to claim 2 that is produced with recyclable material

4. A aquatic habitat according to claim 3 that generally requires no assembly

5. A aquatic habitat according to claim 3 that is generally lightweight

6. A aquatic habitat according to claim 5 that can be shipped by courier

7. A aquatic habitat according to claim 5 that is installed without the installer submerging into the water

8. A aquatic habitat with the versatility of extreme sizes for ocean use

9. A aquatic habitat according to claim 7 that is extremely mobile

10. A aquatic habitat according to claim 9 that by design allows the ease of installation

11. A aquatic habitat according to claim 1 that is designed for structural hydrodynamics

12. A aquatic habitat that by radius design is snag-less to the average fisherman

13. A aquatic habitat according to claim 10 that is a lifetime structure

14. A aquatic habitat according to claim 11 that can be used for collective sampling in a body of water to monitor for exotic animal influx

15. A aquatic habitat according to claim 14 that can be a tool of removal of exotic animal influx from a water system
